(19) United States
(12) Patent Application Publication
(10) Pub. No.: US 2020/0020986 A1
(43) Pub. Date: Jan. 16, 2020

(54) NONAQUEOUS ELECTROLYTE SECONDARY BATTERY

(71) Applicant: Panasonic Intellectual Property Management Co., Ltd., Osaka (JP)

(72) Inventors: Yasuko Hirayama, Osaka (JP); Naoya Morisawa, Hyogo (JP); Takanobu Chiga, Osaka (JP); Kazuhiro Iida, Tokyo (JP); Atsushi Fukui, Hyogo (JP)

(73) Assignee: Panasonic Intellectual Property Management Co., Ltd., Osaka (JP)

(21) Appl. No.: 16/580,212

(22) Filed: Sep. 24, 2019

Related U.S. Application Data
(63) Continuation of application No. PCT/JP2018/004359, filed on Feb. 8, 2018.

(30) Foreign Application Priority Data
Mar. 29, 2017 (JP) 2017-065804

(51) Int. Cl. H01M 10/0569; H01M 10/0568; H01M 4/525; H01M 10/0525; H01M 10/0567

(52) U.S. Cl. CPC H01M 10/0569; H01M 10/0568; H01M 4/525; H01M 2004/028; H01M 10/0567; H01M 2300/0034; H01M 10/0525

(57) ABSTRACT

A nonaqueous electrolyte secondary battery according to one embodiment of the present disclosure comprises a positive electrode having a positive electrode active substance layer, a negative electrode having a negative electrode active substance layer, and a nonaqueous electrolyte. The nonaqueous electrolyte contains a sulfonylimide salt and a nonaqueous solvent containing a fluorinated chain carboxylic acid ester represented by a general formula. The fluorinated chain carboxylic acid ester content of the nonaqueous solvent is 80 vol % or greater and the sulfonylimide salt content is 2.4 mol or greater with respect to 1 L of the nonaqueous solvent. (In the formula, R₁ and R₂ are any one of H, F, and CH₃₋ₓFₓ (where x is 1, 2 or 3), and can be the same or different. R₃ is a C₁-C₃ alkyl group and can contain F.)

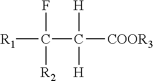

### TECHNICAL FIELD

The present invention relates to a technology of a non-aqueous electrolyte secondary battery.

### BACKGROUND ART

In recent years, as a secondary battery with high output and a high energy density, a non-aqueous electrolyte secondary battery has been widely used, the battery comprising a positive electrode, a negative electrode, and a non-aqueous electrolyte wherein lithium ions are transferred between the positive electrode and the negative electrode to perform charge/discharge.

For example, Patent Literatures 1 and 2 disclose a non-aqueous electrolyte secondary battery comprising a positive electrode, a negative electrode, and a non-aqueous electrolyte including 4-fluoro ethylene carbonate and lithium bis(fluorosulfonyl)imide.

In addition, for example, Patent Literatures 3 discloses a non-aqueous electrolyte secondary battery comprising a positive electrode, a negative electrode, and a non-aqueous electrolyte including 4-fluoro ethylene carbonate, a fluorinated carboxylate ester, and lithium bis(fluorosulfonyl)imide.

### CITATION LIST

### Patent Literature

PATENT LITERATURE 1: Japanese Unexamined Patent Application Publication No. 2010-129449
PATENT LITERATURE 2: International Publication No. WO2014/126256
PATENT LITERATURE 3: US Patent Application Publication No. 2014/0248529

### SUMMARY

However, the non-aqueous electrolyte secondary battery using the conventional non-aqueous electrolyte has a problem of a decrease in capacity recovery rate after high temperature storage. The capacity recovery rate after high temperature storage is, with respect to battery capacity (initial capacity) of the non-aqueous electrolyte secondary battery when charged and discharged at room temperature (for example, 25° C.), a ratio of battery capacity (capacity after storage) of a non-aqueous electrolyte secondary battery when charged and discharged again at room temperature (for example, 25° C.) after storage of the charged non-aqueous electrolyte secondary battery at a high temperature (for example, 60° C. or more) for a predetermined number of days, and is represented by the following formula:

Capacity recovery rate after high temperature storage=capacity after storage/initial capacity×100

Accordingly, an object of the present disclosure is to provide a non-aqueous electrolyte secondary battery capable of suppressing a decrease in capacity recovery rate after high temperature storage.

The non-aqueous electrolyte secondary battery according to one aspect of the present disclosure comprises a positive electrode having a positive electrode active material layer, a negative electrode having a negative electrode active material layer, and a non-aqueous electrolyte, wherein the non-aqueous electrolyte includes a non-aqueous solvent including a fluorinated chain carboxylate ester represented by the following general formula, and a sulfonylimide salt; the content of the fluorinated chain carboxylate ester in the non-aqueous solvent is 80% by volume or more; and the content of the sulfonylimide salt is 2.4 mol or more based on 1 L of the non-aqueous solvent.

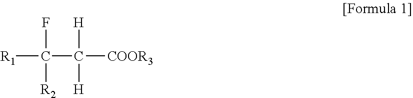

wherein R₁ and R₂ are any of H, F, and CH₃₋ₓFₓ where x is 1, 2, or 3, and may be the same or different from each other; and R₃ is an alkyl group having 1 to 3 carbon atoms and optionally including F.

According to one aspect of the present disclosure, it is possible to suppress a decrease in capacity recovery rate after high temperature storage.

### DESCRIPTION OF EMBODIMENTS

It is known that in the non-aqueous electrolyte secondary battery, a part of the non-aqueous electrolyte is decomposed at initial charge and a film (SEI film) composed of the decomposition product is formed on the electrode surface of the negative electrode or the positive electrode. The formation of this film suppresses the further decomposition of the non-aqueous electrolyte on the electrode. However, since the film formed by the conventional non-aqueous electrolyte lacks thermal stability, the film is likely to be destroyed under a high temperature environment. Therefore, when the non-aqueous electrolyte secondary battery using the conventional non-aqueous electrolyte is stored at a high temperature (for example, 60C or more), the film is destroyed, and the decomposition of the non-aqueous electrolyte may progress in the subsequent charge/discharge. As a result, the capacity of the non-aqueous electrolyte secondary battery after high temperature storage is decreased, which may cause the decrease in capacity recovery rate after high temperature storage as described above. As a result of earnest studies, the present inventors have found that in a non-aqueous electrolyte including the non-aqueous solvent including the fluorinated chain carboxylate ester represented by the following general formula and the sulfonylimide salt, the content of the fluorinated chain carboxylate ester in the non-aqueous solvent is set to 80% by volume or more and the content of the sulfonylimide salt is set to 2.4 mol or more based on 1 L of the non-aqueous solvent, thereby suppressing the decrease in capacity recovery rate after high temperature storage of the non-aqueous electrolyte secondary battery.

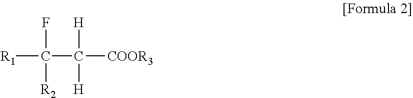

wherein R₁ and R₂ are any of H, F, and CH₃₋ₓFₓ where x is 1, 2, or 3, and may be the same or different from each other, and R₃ is an alkyl group having 1 to 3 carbon atoms and optionally including F.

This mechanism is not clear enough, but the following is inferred. In the non-aqueous electrolyte secondary battery using the non-aqueous electrolyte including the fluorinated chain carboxylate ester and the sulfonylimide salt having the above composition, a composite film including a large amount of the fluorinated imide ester compound provided by the decomposition of the above two substances is assumed to be formed on the electrode at charge/discharge. The composite film is assumed to be a dense and highly thermally stable film. As a result, even when the non-aqueous electrolyte secondary battery is stored at a high temperature, the destruction of the composite film can be suppressed, so that the decomposition of the non-aqueous electrolyte is assumed to be suppressed in the subsequent charge/discharge. The amount of the fluorinated chain carboxylate ester contributing to solvation is increased to lead to stabilization, thereby suppressing excessive decomposition of the fluorinated chain carboxylate ester during high temperature storage and properly forming the composite film including a large amount of the fluorinated imide ester compound. Since the composite film is a film having high ion conductivity, an increase in the resistance value of the electrode is assumed to be suppressed even when the composite film is formed on the electrode. From these things, it is inferred that the decrease in capacity recovery rate after high temperature storage of the non-aqueous electrolyte secondary battery is suppressed.

Hereinafter, the embodiment of the non-aqueous electrolyte secondary battery comprising the non-aqueous electrolyte according to one aspect of the present disclosure will be described. The embodiment described below is an example and the present disclosure is not limited thereto.

The non-aqueous electrolyte secondary battery, which is an example of the embodiment, comprises a positive electrode, a negative electrode, a separator, a non-aqueous electrolyte, and a battery case. Specifically, the non-aqueous electrolyte secondary battery has a structure in which a wound electrode body with the positive electrode and the negative electrode wound together with the separator therebetween, and the non-aqueous electrolyte are accommodated in the battery case. The electrode body is not limited to the wound electrode body, and electrode bodies in other forms may be applied such as a laminated electrode body with the positive electrode and the negative electrode laminated via the separator. The form of the non-aqueous electrolyte secondary battery is not particularly limited, and examples thereof include cylindrical square, coin, button, and laminated types.

Hereinafter, the non-aqueous electrolyte, the positive electrode, the negative electrode, and the separator used for the non-aqueous electrolyte secondary battery which is an example of the embodiment will be described in detail.

### [Non-Aqueous Electrolyte]

The non-aqueous electrolyte includes a non-aqueous solvent inchluding the fluorinated chain carboxylate ester represented by the above general formula, and a sulfonylimide salt. The non-aqueous electrolyte is not limited to a liquid electrolyte (non-aqueous electrolyte solution), and may be a solid electrolyte using a gel-like polymer or the like.

The fluorinated chain carboxylate ester included in the non-aqueous solvent is not particularly limited as long as it is a substance represented by the above general formula, and examples thereof include methyl 3,3,3-trifluoropropionate, methyl 2,3,3,3-tetrafluoropropionate, and methyl 2,3,3-trifluoropropionate. These may be used singly or in combinations of two or more. Among the above examples of the substance, methyl 3,3,3-trifluoropropionate (FMP) is preferable. Using methyl 3,3,3-trifluoropropionate (FMP) not fluorinated at the a position can enhance reactivity with the sulfonylimide salt as compared to other fluorinated chain carboxylate esters, allowing formation of the composite film including a large amount of the fluorinated imide ester compound.

The content of the fluorinated chain carboxylate ester in the non-aqueous solvent is not particularly limited as long as it is 80% by volume or more, and from the viewpoint of being capable of further suppressing the decrease in capacity recovery rate after high temperature storage of the non-aqueous electrolyte secondary battery, 90° % by volume or more is preferable and 95% by volume or more is more preferable. The upper limit of the content of the fluorinated chain carboxylate ester is not particularly limited and may be 100% by volume.

The non-aqueous solvent preferably further contains fluoroethylene carbonate (FEC). The content of fluoroethylene carbonate in the non-aqueous solvent is preferably 0.01% by volume or more and 20% by volume or less, and more preferably 0.1% by volume or more and 5% by volume or less. It is assumed that coexistence of the above contents of the fluoroethylene carbonate and the fluorinated chain carboxylate ester suppresses excessive decomposition of the chain carboxylate ester at the electrode to form an appropriate amount of a film on the electrode (composite film including a large amount of the fluorinated imide ester compound). As a result, the decrease in capacity recovery rate after high temperature storage of the non-aqueous electrolyte secondary battery can be suppressed as compared to the case without the above coexistence. When the content of the fluoroethylene carbonate exceeds 20% by volume, the viscosity of the non-aqueous electrolyte may increase, and the output characteristics of the non-aqueous electrolyte secondary battery may deteriorate, for example.

The non-aqueous solvent preferably further contains 2,2,2-trifluoroethyl acetate (FEA). The content of 2,2,2-trifluoroethyl acetate in the non-aqueous solvent is preferably 0.01% by volume or more and 50% by volume or less, and more preferably 0.1% by volume or more and 5% by volume or less. It is assumed that coexistence of the above contents of 2,2,2-trifluoroethyl acetate and the fluorinated chain carboxylate ester suppresses excessive decomposition of the chain carboxylate ester at the electrode to form an appropriate amount of a film on the electrode (composite film including a large amount of the fluorinated imide ester compound). As a result, the decrease in capacity recovery rate after high temperature storage of the non-aqueous electrolyte secondary battery can be suppressed as compared to the case without the above coexistence.

When the content of 2,2,2-trifluoroethyl acetate exceeds 50% by volume, the film becomes sparse and the thermal stability deteriorates, and the fluorinated chain carboxylic acid is decomposed, and, for example, the output characteristics of the non-aqueous electrolyte secondary battery may deteriorate.

The non-aqueous solvent may include other non-aqueous solvents in addition to the above fluorinated chain carboxylate ester, fluoroethylene carbonate, and 2,2,2-trifluoroethyl acetate. Examples of other non-aqueous solvents include esters such as ethylene carbonate (EC), propylene carbonate (PC), dimethyl carbonate (DMC), methyl ethyl carbonate (EMC), diethyl carbonate (DEC), methyl acetate, ethyl acetate, propyl acetate, and methyl propionate (MP): ethers such as 1,3-dioxolane; nitriles such as acetonitrile; amides such as dimethylformamide: and mixed solvents of two or more of these solvents.

The sulfonylimide salt included in the non-aqueous electrolyte is not particularly limited, and from the viewpoint of being capable of improving the conductivity of the non-aqueous electrolyte and the lithium ion conductivity of the above composite film formed on the electrode, lithium sulfonylimide is preferable.

The lithium sulfonylimide is represented, for example, by the following general formula:

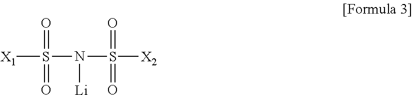

wherein X₁ to X₂ independently represent a fluorine group or a fluoroalkyl group.

Examples of the lithium sulfonylimide represented by the above general formula include lithium bis(fluorosulfonyl)imide (LiFSI), lithium bis(trifluoomiethanesulfonyl)imide, lithium bis(nonafluorobutanesulfonyl)imide, and lithium bis(pentafluoroethanesulfonyl)imide (LIBETI). These may be used singly or in combinations of two or more. Among these, from the viewpoint such as being capable of further suppressing the decrease in capacity recovery rate after high temperature storage of the non-aqueous electrolyte secondary battery, lithium bis(fluorosulfonyl)imide (LiFSI), lithium bis(pentafluoroethanesulfonyl)imide (LIBETI), and the like are preferable.

The content of the sulfonylimide salt is not particularly limited as long as it is 2.4 mol or more based on 1 L of the non-aqueous solvent, and from the viewpoint such as being capable of further suppressing the decrease in capacity recovery rate after high temperature storage of the non-aqueous electrolyte secondary battery, for example, 2.8 mol or more is preferable, and 3.2 mol or more is more preferable. The upper limit of the content of the sulfonylimide salt is not particularly limited, and for example, the content of 5.3 mol or less is preferably used. When the content is greater than this, the viscosity of the non-aqueous electrolyte increases, which may cause the problem in the production of the non-aqueous electrolyte secondary battery.

The non-aqueous electrolyte preferably includes a carboxylic acid anhydride. Including the carboxylic acid anhydride forms the composite film including a large amount of the fluorinated imide ester compound on the negative electrode, allowing suppression of the decrease in capacity recovery rate after high temperature storage as compared to the case without inclusion of the carboxylic acid anhydride. The carboxylic acid anhydride is not particularly limited, and examples thereof include succinic anhydride, glutaric anhydride, diglycolic anhydride, and thiodiglycolic anhydride. These may be used singly or in combinations of two or more. Among these, succinic anhydride is preferable from the viewpoint such as being capable of improving the battery capacity of the non-aqueous electrolyte secondary battery. The content of the carboxylic acid anhydride in the non-aqueous electrolyte is not particularly limited, and is preferably, for example, 0.1 mass % or more and 5 mass % or less.

The non-aqueous electrolyte may contain additives such as vinylene carbonate (VC), ethylene sulfite (ES), lithium bis(oxalato) borate (LiBOB), cyclohexylbenzene (CHB), and ortho terphenyl (OTP). Among these, vinylene carbonate (VC) is preferable from the viewpoint such as being capable of improving the battery capacity of the non-aqueous electrolyte secondary battery. The content of the additive in the non-aqueous electrolyte is not particularly limited, and is preferably, for example, 0.1 mass % or more and 5 mass % or less.

The non-aqueous electrolyte may include a supporting salt generally used in the conventional non-aqueous electrolyte secondary battery. Examples of the general supporting salt include LiPF₆, LiBF₄. LiAsF₆. LiClO₄, LiCF₃SO₃, Li[B(C₂O₄)₂], Li[B(C₂O₄)F₂], Li[P(C₂O₄)F₄], and Li[P(C₂O₄)₂F₂]. These general supporting salts may be used singly or in combinations of two or more.

[Positive Electrode]

The positive electrode is composed oft for example, a positive electrode current collector such as a metal foil, and a positive electrode active material layer formed on the positive electrode current collector. As the positive electrode current collector, a foil of a metal, such as aluminum, that is stable in the electric potential range of the positive electrode, a film in which the metal is disposed on an outer layer, and the like can be used. The positive electrode active material layer includes, for example, a positive electrode active material, a binder, and an electrical conductor.

The positive electrode is obtained, for example, by applying and drying a positive electrode mixture slurry including a positive electrode active material, a binder, an electrical conductor, and the like onto the positive electrode current collector to form the positive electrode active material layer on the positive electrode current collector and by rolling the positive electrode active material layer.

Examples of the positive electrode active material include lithium transition metal composite oxide, and specific examples thereof include lithium-cobalt composite oxide, lithium-manganese composite oxide, lithium-nickel composite oxide, lithium nickel manganese composite oxide, and lithium nickel cobalt composite oxide. These may be used singly or in combinations of two or more.

Lithium-nickel composite oxide can increase the capacity of non-aqueous electrolyte secondary battery, but is likely to cause the decrease in capacity recovery rate after high temperature storage of the non-aqueous electrolyte secondary battery. Particularly, the lithium-nickel composite oxide which a proportion of nickel based on the total number of moles of metal elements excluding lithium in the lithium-nickel composite oxide is 30 mol % or more leads to significant decrease in capacity recovery rate after high temperature storage. However, the non-aqueous electrolyte including a predetermined amount of the above fluorinated chain carboxylate ester and a predetermined amount of the above sulfonylimide salt is combined with the lithium-nickel composite oxide allowing achievement of both the increase in capacity of the non-aqueous electrolyte secondary battery and the suppression of decrease in capacity recovery rate after high temperature storage. Particularly, the non-aqueous electrolyte is combined with the lithium-nickel composite oxide which the proportion of nickel based on the total number of moles of metal elements excluding lithium in the lithium-nickel composite oxide is 30 mol % or more allowing achievement of both the increase in capacity of the non-aqueous electrolyte secondary battery and the suppression of decrease in capacity recovery rate after high temperature storage.

The lithium-nickel composite oxide is preferably a lithium-nickel composite oxide represented by the general formula LiₓNi_{y}Mo_{(1-y)}O₂ (where 0.1≤x≤1.2, 0.3≤y≤1, and M is at least one metal element). Examples of the metal element M include Co, Mn, Mg, Zr, Al, Cr, V, Ce, Ti. Fe, K. Ga, and In. Among these, from the viewpoint such as increasing the capacity of the non-aqueous electrolyte secondary battery, at least one of cobalt (Co), manganese (Mn), and aluminum (Al) is preferably included, and Co and Al are more preferably included.

A proportion of nickel based on the total number of moles of metal elements excluding lithium in the above lithium-nickel composite oxide is preferably 30 mol % or more, more preferably 50 mol % or more, and more preferably 80 mol % or more. The lithium-nickel composite oxide having a nickel content ratio of 30 mol % or more is combined with the non-aqueous electrolyte including a predetermined amount of the above fluorinated chain carboxylate ester and a predetermined amount of the above sulfonylimide salt, allowing achievement of both the increase in capacity of the non-aqueous electrolyte secondary battery and the suppression of decrease in capacity recovery rate after high temperature storage.

The content of the lithium-nickel composite oxide in the positive electrode active material is, for example, preferably 50 mass % or more, and more preferably 80 mass % or more. When the content of the lithium-nickel composite oxide in the positive electrode active material is less than 50 mass %, the capacity of the non-aqueous electrolyte secondary battery may be decreased as compared to the case where the above range is satisfied. The upper limit of the content of the lithium-nickel composite oxide is not particularly limited, and may be, for example, 100 mass %.

Examples of the electrical conductor include carbon powders such as carbon black, acetylene black, ketjen black, and graphite. These may be used singly or in combinations of two or more.

Examples of the binder include fluorine polymers and rubber polymers. Examples of the fluorine polymer include polytetrafluoroethylene (PTFE), polyvinylidene fluoride (PVdF), and modified products thereof, and examples of the rubber polymer include ethylene-propylene-isoprene copolymer and ethylene-propylene-butadiene copolymer. These may be used singly or in combinations of two or more.

The positive electrode active material layer preferably includes a lithium salt in addition to the above positive electrode active material and the like. Including the lithium salt in the positive electrode active material layer is assumed to suppress the decomposition of the fluorinated chain carboxylate ester in the positive electrode during high temperature storage, and the decrease in capacity recovery rate after high temperature storage of the non-aqueous electrolyte secondary battery is further suppressed as compared to the case where the lithium salt is not included in the positive electrode active material layer or the negative electrode active material layer.

Examples of the lithium salt included in the positive electrode active material layer include lithium sulfate, lithium phosphate (Li₃PO₄), and lithium borate, and among these, lithium phosphate is preferable.

The content of the lithium salt in the positive electrode active material is, for example, preferably 0.1 mass % or more and 5 mass % or less from the viewpoint such as suppressing the decrease in capacity recovery rate after high temperature storage of the non-aqueous electrolyte secondary battery.

The average particle size D (μm) of the lithium salt is preferably less than 150 μm. As a result, the formability of the electrode material can be maintained. The average particle size D (μm) is, for example, a median size (D50) measured by a laser diffraction particle size distribution measuring apparatus.

[Negative Electrode]

The negative electrode comprises, for example, a negative electrode current collector, such as a metal foil, and a negative electrode active material layer formed on the negative electrode current collector. As the negative electrode current collector, a foil of a metal, such as copper, that is stable in the electric potential range of the negative electrode, a film in which the metal is disposed on an outer layer, and the like can be used. The negative electrode active material layer includes, for example, a negative electrode active material, a binder, and a thickener.

The negative electrode is obtained, for example, by applying and drying a negative electrode mixture shiny including a negative electrode active material, a thickener, and a binder onto the negative electrode current collector to form the negative electrode active material layer on the negative electrode current collector and by rolling the negative electrode active material layer.

The negative electrode active material is not particularly limited as long as it is a material capable of absorbing and desorbing lithium ions, and examples thereof include lithium alloy such as metallic lithium, lithium-aluminum alloy, lithium-lead alloy, lithium-silicon alloy, and lithium-tin alloy; carbon materials such as graphite, coke, and organic sintered body; and metal oxides such as SnO₂, SnO, and TiO₂. These may be used singly or in combinations of two or more.

As the binder, for example, as in the case of the positive electrode, a fluorine polymer, a rubber polymer, or the like can also be used, and styrene-butadiene copolymer (SBR) or a modified product thereof may also be used.

Examples of the thickener include carboxymethylcellulose (CMC) and polyethylene oxide (PEO). These may be used singly or in combinations of two or more.

The negative electrode active material layer preferably includes a lithium salt in addition to the above negative electrode active material and the like. It is assumed that including the lithium salt in the negative electrode active material layer suppresses excessive decomposition of chain carboxylate ester in the negative electrode to form an appropriate amount of a film on the negative electrode (composite film including a large amount of the fluorinated imide ester compound), and the decrease in capacity recovery rate after high temperature storage of the non-aqueous electrolyte secondary battery is further suppressed as compared to the case where the lithium salt is not included in the positive electrode active material layer or the negative electrode active material layer.

Examples of the lithium salt included in the negative electrode active material layer include lithium sulfate (Li₂SO₄), lithium phosphate, and lithium borate, and among these, lithium sulfate is preferable. The content of the lithium salt in the negative electrode active material is, for example, preferably 0.1 mass % or more and 5 mass % or less from the viewpoint such as suppressing the decrease in capacity recovery rate after high temperature storage of the non-aqueous electrolyte secondary battery.

The average particle size D (μm) of the lithium salt is preferably less than 150 μm. As a result, the formability of the electrode material can be maintained. The average particle size D (μm) is, for example, a median size (D50) measured by a laser diffraction particle size distribution measuring apparatus.

It is assumed that a composite film including a large amount of sulfonyl ions derived from the decomposition product of the fluorinated carboxylate ester and the sulfonylimide salt is formed on the surface of the negative electrode. For example, the XPS spectrum obtained by XPS measurement of the surface of the negative electrode allows confirmation of the presence of the composite film including a large amount of sulfonyl ions formed by decomposition of the fluorinated carboxylate ester and the sulfonylimide salt on the surface of the negative electrode during initial charge/discharge of a battery. For example, on the surface of the negative electrode in the case of using lithium bis(fluorosulfonyl)imide as a sulfonylimide salt, peaks such as Li2S including S element derived from sulfonyl ions and S—S bond can be confirmed. Furthermore, when the total amount of Li, S, C, N, O, and F which are main constituent elements of the composite film is calculated as 100 atomic %, the S atom is included at a ratio of 1% or more (S atomic %=S/[Li+S+C+N+O+F]).

[Separator]

As the separator, for example, a porous sheet or the like having ion permeability and insulating property is used. Specific examples of the porous sheet include a microporous thin film, woven fabric, and non-woven fabric. As the material of the separator, olefin resins such as polyethylene and polypropylene, cellulose, and the like are suitable. The separator may be a laminate having a cellulose fiber layer and a thermoplastic resin fiber layer such as an olefin resin. A multi-layered separator including a polyethylene layer and a polypropylene layer may be used, and a separator coated with a material such as an aramid resin or a ceramic on the surface of the separator may be used.

### EXAMPLES

Hereinafter, the present disclosure will be described in more detail with reference to Examples, but the present disclosure is not limited to the following Examples.

### Example 1

[Production of Positive Electrode]

As a positive electrode active material, a lithium-nickel composite oxide represented by LiNi_{0.82}Co_{0.15}Al_{0.03}O₂ (NCA) was used. After mixing the positive electrode active material (NCA), acetylene black, and polyvinylidene fluoride in a mass ratio of 100:1:0.9, an appropriate amount of N-methyl-2-pyrrolidone (NMP) was added to prepare a positive electrode mixture slurry. Thereafter, this positive electrode mixture slurry was applied to both surfaces of a positive electrode current collector consisting of an aluminum foil. The applying film was dried and then rolled using a rolling roller to produce a positive electrode in which a positive electrode active material layer was formed on both surfaces of the positive electrode current collector.

[Production of Negative Electrode]

Artificial graphite as a negative electrode active material, sodium salt of carboxymethylcellulose (CMC-Na) as a thickener, and a styrene-butadiene copolymer (SBR) as a binder were mixed in a mass ratio of 100:1:1 in an aqueous solution to prepare a negative electrode mixture slurry. Thereafter, this negative electrode mixture slurry was uniformly applied to both surfaces of a negative electrode current collector consisting of a copper foil. The applying film was dried and then rolled using a rolling roller to produce a negative electrode in which a negative electrode active material layer was formed on both surfaces of the positive electrode current collector.

[Preparation of Non-Aqueous Electrolyte]

In 1 L of non-aqueous solvent of methyl 3,3,3-trifluoropropionate (FMP), lithium bis(fluorosulfonyl)imide (LiFSI) was dissolved at a content of 2.8 mol and 1 mass % of vinylene carbonate (VC) was dissolved to prepare a non-aqueous electrolyte.

[Production of Non-Aqueous Electrolyte Secondary Battery]

Lead terminals were attached to the above positive electrode and the above negative electrode, respectively. An electrode body was produced so that the positive electrode and the negative electrode faced each other via the separator interposed therebetween, and the electrode body was enclosed in a laminate exterior body made of aluminum together with the above non-aqueous electrolyte solution. This was the non-aqueous electrolyte secondary battery in Example 1.

### Example 2

For preparation of the non-aqueous electrolyte, a non-aqueous electrolyte was prepared in the same manner as in Example 1, except that lithium bis(fluorosulfonyl)imide was dissolved at a content of 4.7 mol in 1 L of methyl 3,3,3-trifluoropropionate (FMP) as a non-aqueous solvent. Using this as the non-aqueous electrolyte in Example 2, a non-aqueous electrolyte secondary battery was produced in the same manner as in Example 1.

### Example 3

For preparation of the non-aqueous electrolyte, a non-aqueous electrolyte was prepared in the same manner as in Example 1, except that a mixed solvent obtained by mixing methyl 3,3,3-trifluoropropionate (FMP) and fluoroethylene carbonate (FEC) in a volume ratio of 95:5 was used as a non-aqueous solvent. Using this as the non-aqueous electrolyte in Example 3, a non-aqueous electrolyte secondary battery was produced in the same manner as in Example 1.

### Example 4

For preparation of the non-aqueous electrolyte, a non-aqueous electrolyte was prepared in the same manner as in Example 1, except that a mixed solvent obtained by mixing methyl 3,3,3-trifluoropropionate (FMP), 2,2,2-trifluoroethyl acetate (FEA), and fluoroethylene carbonate (FEC) in a volume ratio of 90:5:5 was used as a non-aqueous solvent. Using this as the non-aqueous electrolyte in Example 4, a non-aqueous electrolyte secondary battery was produced in the same manner as in Example 1.

### Example 5

For preparation of the non-aqueous electrolyte, a non-aqueous electrolyte was prepared in the same manner as in Example 1, except that a mixed solvent obtained by mixing methyl 3,3,3-trifluoropropionate (FMP) and fluoroethylene carbonate (FEC) in a volume ratio of 80:20 was used as a non-aqueous solvent. Using this as the non-aqueous electrolyte in Example 5, a non-aqueous electrolyte secondary battery was produced in the same manner as in Example 1.

### Example 6

For preparation of the non-aqueous electrolyte, a non-aqueous electrolyte was prepared in the same manner as in Example 1, except that lithium bis(fluorosulfonyl)imide (LiFSI) was dissolved at a content of 2.4 mol and 0.3 mol of LiPF₆ was dissolved in 1 L of methyl 3,3,3-trifluoropropionate (FMP) as the non-aqueous solvent. Using this as the non-aqueous electrolyte in Example 6, a non-aqueous electrolyte secondary battery was produced in the same manner as in Example 1.

### Example 7

For preparation of the non-aqueous electrolyte, a non-aqueous electrolyte was prepared in the same manner as in Example 1, except that 0.5 mass % of succinic acid was dissolved in methyl 3,3,3-trifluoropropionate (FMP) as the non-aqueous solvent. Using this as the non-aqueous electrolyte in Example 7, a non-aqueous electrolyte secondary battery was produced in the same manner as in Example 1.

### Example 8

For production of the negative electrode, a negative electrode was produced in the same manner as in Example 1, except that artificial graphite as a negative electrode active material, sodium salt of carboxyethylcellulose (CMC-Na) as a thickener, styrene-butadiene copolymer (SBR) as a binder, and lithium sulfate were mixed in a mass ratio of 100:1:1:0.5 and an appropriate amount of water was added to prepare a negative electrode mixture slurry. Using this as the negative electrode in Example 8, a non-aqueous electrolyte secondary battery was produced in the same manner as in Example 1.

### Example 9

For production of the positive electrode, a positive electrode was produced in the same manner as in Example 1, except that the positive electrode active material (NCA), acetylene black, polyvinylidene fluoride, and lithium phosphate were mixed in a mass ratio of 100:1:0.9:0.5 and an appropriate amount of N-methyl-2-pyrrolidone (NMP) was then added to prepare a positive electrode mixture slurry. Using this as the positive electrode in Example 9, a non-aqueous electrolyte secondary battery was produced in the same manner as in Example 1.

### Example 10

Using the negative electrode in Example 8 and the positive electrode in Example 9, a non-aqueous electrolyte secondary battery was produced in the same manner as in Example 1.

### Example 11

For preparation of the non-aqueous electrolyte, a non-aqueous electrolyte was prepared in the same manner as in Example 1, except that lithium bis(pentafluoroethanesulfonyl)imide (LIBETI) was dissolved at a content of 2.8 mol in 1 L of methyl 3,3,3-trifluoropropionate (FMP) as the non-aqueous solvent. Using this as the non-aqueous electrolyte in Example 11, a non-aqueous electrolyte secondary battery was produced in the same manner as in Example 1.

### Comparative Example 1

For preparation of the non-aqueous electrolyte, a non-aqueous electrolyte was prepared in the same manner as in Example 1, except that LiPF₆ was dissolved at a content of 2.8 mol in 1 L of methyl 3,3,3-trifluoropropionate (FMP) as the non-aqueous solvent. Using this as the non-aqueous electrolyte in Comparative Example 1, a non-aqueous electrolyte secondary battery was produced in the same manner as in Example 1.

### Comparative Example 2

For preparation of the non-aqueous electrolyte, a non-aqueous electrolyte was prepared in the same manner as in Example 1, except that lithium bis(fluorosulfonyl)imide was dissolved at a content of 1.3 mol in 1 L of methyl 3,3,3-trifluoropropionate (FMP) as the non-aqueous solvent. Using this as the non-aqueous electrolyte in Comparative Example 2, a non-aqueous electrolyte secondary battery was produced in the same manner as in Example 1.

### Comparative Example 3

For preparation of the non-aqueous electrolyte, a non-aqueous electrolyte was prepared in the same manner as in Example 1, except that lithium bis(fluorosulfonyl)imide was dissolved at a content of 2.1 mol in 1 L of methyl 3,3,3-trifluoropropionate (FMP) as the non-aqueous solvent. Using this as the non-aqueous electrolyte in Comparative Example 3, a non-aqueous electrolyte secondary battery was produced in the same manner as in Example 1.

### Comparative Example 4

For preparation of the non-aqueous electrolyte, a non-aqueous electrolyte was prepared in the same manner as in Example 1, except that lithium bis(fluorosulfonyl)imide was dissolved at a content of 1.26 mol and LiPF6 was dissolved at a content of 1.21 mol in 1 L of methyl 3,3,3-trifluoropropionate (FMP) as the non-aqueous solvent. Using this as the non-aqueous electrolyte in Comparative Example 4, a non-aqueous electrolyte secondary battery was produced in the same manner as in Example 1.

### Comparative Example 5

For preparation of the non-aqueous electrolyte, a non-aqueous electrolyte was prepared in the same manner as in Example 1, except that a mixed solvent obtained by mixing methyl 3,3,3-trifluoropropionate (FMP) and fluoroethylene carbonate (FEC) in a volume ratio of 70:30 was used as the non-aqueous solvent. Using this as the non-aqueous electrolyte in Comparative Example 5, a non-aqueous electrolyte secondary battery was produced in the same manner as in Example 1.

[Measurement of Capacity Recovery Rate after High Temperature Storage]

For the non-aqueous electrolyte secondary batteries in Examples and Comparative Examples, the capacity recovery rate after high temperature storage was measured under the following conditions. The battery was charged to a voltage of 4.2 V with a constant current of 0.2 C at an environmental temperature of 25° C. and was then charged at a constant voltage of 4.2 V until the current value reached 0.05 C to complete charging (this charging is referred to as charge A). After resting for 20 minutes, a constant current discharging was performed at a constant current of 0.2 C until the voltage reached 2.5 V (this discharging is referred to as discharge A), and after resting for 20 minutes, charge A was performed again, and after resting for 20 minutes, discharge A was performed to stabilize the battery. After resting for another 20 minutes, charge A was performed, and after 20 minutes, discharge A was performed, and the discharge capacity at that time was taken as the initial capacity. After resting for 20 minutes, only the above charge A was performed, and then stored at an environmental temperature of 60-C for 5 days. After the storage, the temperature was lowered to room temperature, and then only the above discharge A was performed. After resting for 20 minutes, the above charge A was performed, and after resting for 20 minutes, the above discharge A was performed, and the discharge capacity at that time was taken as the capacity after storage. The capacity recovery rate after high temperature storage was determined by the following formula:

Capacity recovery rate after high temperature storage (%)=capacity after storage/initial capacity×100

Table 1 shows the composition of the positive electrode, the negative electrode, the non-aqueous electrolyte used in each Example, and the results of the capacity recovery rate after high temperature storage of the non-aqueous electrolyte secondary battery in each Example. Table 2 shows the composition of the positive electrode, the negative electrode, the non-aqueous electrolyte used in each Comparative Example, and the results of the capacity recovery rate after high temperature storage of the non-aqueous electrolyte secondary battery in each Comparative Example.

TABLE 1

| | | | Non-aqueous electrolyte | | | |
|---|---|---|---|---|---|---|
| | Positive | | Li salt (mol/1 L of | Non-aqueous solvent | | Capacity recovery ratio after |
| | electrode | Negative electrode | non-aqueous solvent) | (volume ratio) | Additive (mass %) | high temperature storage |
| Example 1 | NCA | Artificial graphite | LiFSI (2.8) | FMP | VC (1.0) | 89% |
| Example 2 | NCA | Artificial graphite | LiFSI (4.7) | FMP | VC (1.0) | 91% |
| Example 3 | NCA | Artificial graphite | LiFSI (2.8) | FMP/FEC | VC (1.0) | 92% |
| | | | | (95/5) | | |
| Example 4 | NCA | Artificial graphite | LiFSI (2.8) | FMP/FEA/FEC | VC (1.0) | 93% |
| | | | | (90/5/5) | | |
| Example 5 | NCA | Artificial graphite | LiFSI (2.8) | FMP/FEC | VC (1.0) | 91% |
| | | | | (80/20) | | |
| Example 6 | NCA | Artificial graphite | LiFSI/LiPF₆ | FMP | VC (1.0) | 89% |
| | | | (2.4/0.3) | | | |
| Example 7 | NCA | Artificial graphite | LiFSI (2.8) | FMP | VC/succinic acid | 90% |
| | | | | | (1.0/0.5) | |
| Example 8 | NCA | Artificial graphite/ | LiFSI (2.8) | FMP | VC (1.0) | 91% |
| | | Li₂SO₃ | | | | |
| Example 9 | NCA/ | Artificial graphite | LiFSI (2.8) | FMP | VC (1.0) | 92% |
| | Li₃PO₄ | | | | | |
| Example 10 | NCA/ | Artificial graphite/ | LiFSI (2.8) | FMP | VC (1.0) | 95% |
| | Li₃PO₄ | Li₂SO₄ | | | | |
| Example 11 | NCA | Artificial graphite | LiBETI (3.5) | FMP | VC (1.0) | 90% |

TABLE 2

| | | | Non-aqueous electrolyte | | | |
|---|---|---|---|---|---|---|
| | Positive | | Li salt (mol/1 L of | Non-aqueous solvent | | Capacity recovery ratio after |
| | electrode | Negative electrode | non-aqueous solvent) | (volume ratio) | Additive (mass %) | high temperature storage |
| Comparative | NCA | Artificial graphite | LiPF₆ (2.7) | FMP | VC (1.0) | 83% |
| Example 1 | | | | | | |
| Comparative | NCA | Artificial graphite | LiFSI (1.3) | FMP | VC (1.0) | 87% |
| Example 2 | | | | | | |
| Comparative | NCA | Artificial graphite | LiFSI (2.1) | FMP | VC (1.0) | 87% |
| Example 3 | | | | | | |
| Comparative | NCA | Artificial graphite | LiFSI/LiPF₆ | FMP | VC (1.0) | 86% |
| Example 4 | | | (1.26/1.21) | | | |
| Comparative | NCA | Artificial graphite | LiFSI (2.8) | FMP/FEC | VC (1.0) | 87% |
| Example 5 | | | | (70/30) | | |

The non-aqueous electrolyte secondary batteries in Examples 1 to 11 exhibited high values of capacity recovery rate after high temperature storage, compared with the non-aqueous electrolyte secondary batteries in Comparative Examples 1 to 5. It can be deemed from these results that the non-aqueous electrolyte is used, the non-aqueous electrolyte including the non-aqueous solvent including the fluorinated chain carboxylate ester represented by the above general formula and the sulfonylimide salt, wherein the content of the fluorinated chain carboxylate ester in the non-aqueous solvent is 80% by volume or more and the content of the sulfonylimide salt is 2.4 mol or mere based on 1 L of the non-aqueous solvent, thereby allowing suppression of the decrease in capacity recovery rate after high temperature storage of the non-aqueous electrolyte secondary battery.

In Examples 1 to 11, Example 2 in which the content of sulfonylimide salt (LiFSI) was 4.7 mol based on 1 L of the non-aqueous solvent, Examples 3 to 5 including a predetermined amount of FEC and a predetermined amount of FEA, Examples 8 to 10 in which a lithium salt was added to the positive electrode or the negative electrode, and Example 11 in which LiBETI was used as a sulfonylimide salt showed capacity recovery rate after high temperature storage exceeding 90%.

1. A non-aqueous electrolyte secondary battery, comprising:
a positive electrode having a positive electrode active material layer;
a negative electrode having a negative electrode active material layer; and
a non-aqueous electrolyte, wherein
the non-aqueous electrolyte includes a non-aqueous solvent including a fluorinated chain carboxylate ester represented by Formula 1, and a sulfonylimide salt;
a content of the fluorinated chain carboxylate ester in the non-aqueous solvent is 80% by volume or more; and
a content of the sulfonylimide salt is 2.4 mol or more based on 1 L of the non-aqueous solvent, 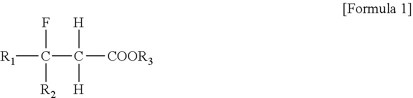
wherein R₁ and R₂ are any of H, F, and CH₃₋ₓFₓ where x is 1, 2, or 3, and are identical to or different from each other; and R₃ is an alkyl group having 1 to 3 carbon atoms.

2. The non-aqueous electrolyte secondary battery according to claim 1, wherein the fluorinated chain carboxylate ester includes methyl 3,3,3-trifluoropropionate.

3. The non-aqueous electrolyte secondary battery according to claim 1, wherein the sulfonylimide salt includes lithium bis(fluorosulfonyl)imide.

4. The non-aqueous electrolyte secondary battery according to claim 1, wherein the non-aqueous solvent includes fluoroethylene carbonate (FEC), and a content of the fluoroethylene carbonate in the non-aqueous solvent is 0.1% by volume or more and 5% by volume or less.

5. The non-aqueous electrolyte secondary battery according to claim 1, wherein the non-aqueous solvent includes 2,2,2-trifluoroethyl acetate (FEA), and a content of the 2,2,2-trifluoroethyl acetate in the non-aqueous solvent is 0.1% by volume or more and 5% by volume or less.

6. The non-aqueous electrolyte secondary battery according to claim 1, wherein the non-aqueous electrolyte includes a carboxylic acid anhydride.

7. The non-aqueous electrolyte secondary battery according to claim 1, wherein the positive electrode active material layer includes a lithium salt.

8. The non-aqueous electrolyte secondary battery according to claim 1, wherein the negative electrode active material layer includes a lithium salt.

9. The non-aqueous electrolyte secondary battery according to claim 1, wherein the positive electrode active material layer includes a lithium-nickel composite oxide, and a proportion of nickel based on the total number of moles of metal elements excluding lithium in the lithium-nickel composite oxide is 30 mol % or more.

10. The non-aqueous electrolyte secondary battery according to claim 1, wherein the R₃ further contain F.
